(19) United States
(12) Patent Application Publication
(10) Pub. No.: US 2002/0001108 A1
(43) Pub. Date: Jan. 3, 2002

(54) Curved lens having hologram and method for fabricating the same

(75) Inventor: Wan-gu Yeo, Suwon-city (KR)

Correspondence Address: ROTHWELL, FIGG, ERNST & MANBECK, P.C., 555 13TH STREET, N.W., SUITE 701, EAST TOWER, WASHINGTON, DC, 20004, US

(73) Assignee: WAYTECH CO., LTD

(21) Appl. No.: 09/852,144

(22) Filed: May 10, 2001

(30) Foreign Application Priority Data
Nov. 11, 1999 (KR) 99-50034

(51) Int. Cl. G03H 1/02; G02B 5/20; F21V 9/06

(52) U.S. Cl. 359/8; 359/361

(57) ABSTRACT

The present invention provides a curved lens having a hologram and a method of fabricating the same. In this method, a chromium-plated metal plate on which a hologram is formed is fixed to a moving plate of an injection mold having a curved cavity, and plastic resin is injected and molded. Thus, the metal plate is stretched or elongated, and simultaneously, the hologram of an elongated metal plate is transferred to the plastic resin. Then, a highly refractive material is deposited on the injected plastic, and the resultant structure is coated with a UV-blocking material. In this way, the curved lens having a hologram is fabricated. The plastic curved lens passes the standard values for sunglass lenses in terms of power and parallelism, and can obtain a distinct hologram image by completely preventing generation of color stripes which is the most serious problem in existing plastic curved lenses. Also, the curved hologram lens according to the present invention, does not strain the eyes of lens-wearers since no stripes and no distortion are generated upon assembly with the rim of a pair of eyeglasses, in contrast with plane lenses. Therefore, the hologram lens is applicable to sunglass lenses and various laser goggles.

### BACKGROUND OF THE INVENTION

1. Field of the Invention

The present invention relates to a curved lens having a hologram and a method of fabricating the same.

2. Description of the Related Art

Holograms are interference patterns made by separating coherent laser light into an object wave and a standard wave and causing the two waves to interfere with each other. The interference pattern is distinguished from a general photograph, which records only the intensity of light, in that all information associated with the image of an object, that is, the intensity of light and the phase thereof, are recorded together on the interference pattern. In order to record the interference pattern produced by the object wave and the standard wave of laser light interfering with each other, a photosensitive material, such as dichromated gelatin, photo polymer or the like, which is called photoresist, is used.

Laser wavelengths for photosensitization include Ar-ion (514 nm), He—Ne (633 nm), Kr-ion (413 nm or 647.1 nm) and He—Cd (442 nm). A hologram interference pattern formed on photoresist appears through etching. The thus-fabricated hologram is typically referred to as a master hologram. In order to replicate the master hologram, a conductive layer is formed on a surface having an interference pattern, and a metal plate to which a hologram interference pattern has been transferred through plating is obtained.

As a technique of mass replicating a hologram, U.S. Pat. No. 4,900,111 to D'Amato et al. discloses a method of fabricating a hologram aluminum CAM through mass replication of a hologram by engraving an aluminum plate with a metal plate to which a hologram interference pattern has been transferred by rolling the metal plate. Also, U.S. Pat. Nos. 5,759,683 (Boswell et al.), 5,817,205 (Kaule et al.), 5,807,456 (Kaule et al.), 5,810,957 (Boswell et al.) and 5,857,709 (Chock et al.) disclose a method of fabricating a film having a film layer, a deformed layer, a resin layer, a metal layer embossed with a hologram, and an adhesive layer, a technique of fabricating a hologram stamping foil for preventing replication of stocks and bonds or important documents, and application techniques of a stamping method. Also, U.S. Pat. Nos. 4,838,965 (Bussard et al.), 5,786,587 (Colgate et al.) and 5,895,541 (Kobabayasi et al.) disclose techniques of applying a stamping method, which is a thermal transcribing method, to shirts or cloth, plastic cards, and a timepiece face. Korean Publication No. 1998-163531 to Jongdal Lee et al. discloses a method for applying an adhesive coating to a film layer, a resin layer and a metal layer on which a hologram has been formed, and utilizing the resultant layer as a sticker for vehicle adhesion. U.S. Pat. Nos. 4,893,887 (Coates et al.) and 5,626,702 (Sharpe et al.) disclose a method of attaching a film to a plastic or a flexible material and utilizing the resultant film as a packing paper. There is also known a method of making a master disc by placing a grating or a hologram at a portion of a compact disc where a digital signal is not recorded, and molding the grating or hologram using a master hologram (see U.S. Pat. No. 5,843,626 to Ohta et al.).

In the transcribing, attachment, adhesion and molding techniques of these conventional holograms, an object does not escape from the category of a plane since a hologram interference pattern can be recorded on only a flat photosensitive plate during the manufacture of the master hologram. There is a limit in applying these techniques to a three-dimensional curved surface. U.S. Pat. No. 5,892,600 to Kuo et al. discloses an example of an application of the hologram techniques to eye glasses, but does not get out of the category of techniques which involve engraving a flat plate with a hologram.

Accordingly, the necessity of the development of new techniques of engraving a curved surface with a hologram has been continued.

### SUMMARY OF THE INVENTION

The inventors of the present invention have ascertained from the results of their research into developing a technique of engraving a curved object with a hologram, that when plastic resin is injection-molded after a metal plate on which a hologram has been engraved is fixed to a moving plate of an injection mold having a curved cavity, the metal plate is stretched or elongated uniformly, and simultaneously, the hologram of the stretched or elongated metal plate can be transferred to the plastic resin. Through this research, the present invention has been completed.

Accordingly, an object of the present invention is to provide a curved lens having a hologram which can be applied in several areas and repeatedly produced.

Another object of the present invention is to provide a method for fabricating the above curved lens To achieve the above object, there is provided a curved lens having a hologram, the curved lens comprising a curved plastic resin, a hologram which is formed on the curved plastic resin, a highly refractive film which is formed on the plastic resin having the hologram, and an ultraviolet (UV)-blocking material film which is formed on the highly refractive film.

The highly refractive film is a refractive film having a refractive index of about 2.0-2.5.

The plastic resin is an acrylate polymer.

The UV-blocking material film is an acrylate polymer.

To achieve the another object, there is provided a method of fabricating a curved lens having a hologram, the method comprising steps of forming a hologram on a metal plate, plating the metal plate on which the hologram is formed, forming a injected plastic which is curved and the hologram is formed, using an injection-molding, forming a highly refractive material film on the injected plastic on which the hologram is formed, and coating an ultraviolet (UV)-blocking material film on the highly refractive material film.

A metal plate is plated using nickel or copper.

The highly refractive material film is formed of a material film having a refractive index of 2.0 to 2.5.

The step of forming a injected plastic further comprises steps of fixing the metal plate to a moving plate of an injection mold having a curved cavity and elongating the metal plate injection-molding a plastic resin and, simultaneously, transferring the hologram of the elongated metal plate to the plastic resin.

### BRIEF DESCRIPTION OF THE DRAWINGS

The above objects and advantages of the present invention will become more apparent by describing in detail a preferred embodiment thereof with reference to the attached drawings in which:

FIG. 1 is a schematic view illustrating an injection process in which a metal plate on which a hologram has been engraved, the metal plate fixed to a moving plate of an injection mold, is stretched or elongated; and

FIG. 2 is a side cross-sectional view of a curved lens having a hologram, the curved lens fabricated by a method according to the present invention.

### DESCRIPTION OF THE PREFERRED EMBODIMENT

A curved lens having a hologram and a method of fabricating the same, according to the present invention, will now be described by processes in detail.

<First process: Plating of a metal plate>

A metal plate engraved with a hologram is plated with chromium. Here, the metal plate must be flexible so that it can be deformed into a cavity of an injection mold by an injection pressure upon injection to be described later. Hence, the metal plate can be formed of an element selected from among the transfer metal elements pertaining to IB through VIIIB families, or an alloy of two or more elements. Preferably, the metal plate is made of a metal such as nickel, copper or the like. Also, the surface of the metal plate must be plated to prevent the engraved hologram pattern from being damaged during injection, and, preferably, plated with chromium to strengthen the hologram pattern part. In this case, the thickness of the plating must be 50 to 500 μm, and preferably, 60 to 200 μm. When the thickness of the plating is less than 50 μm, it may get torn during stretching or elongation upon injection to be described later. When the thickness of the plating exceeds 500 μm, it is too thick to undergo stretching or elongation, and the plating may be torn upon injection.

<Second process: Injection of plastic resin and stretching or elongation of a plated metal plate>

The metal plate engraved with a hologram is fixed to a moving plate of an injection mold having a curved cavity. Then, a plastic resin is injection-molded, so that the metal plate is stretched or elongated, and simultaneously, the hologram of the stretched or elongated metal plate is transferred to the plastic resin. Here, various resins can be used as the plastic resin, depending on the purposes of a product. Preferably, acrylate polymer is used for lenses for sunglasses, but more preferably, polymethylmetacrylate is used therefor.

Also, the flexible metal plate is stretched or elongated by a high pressure for injection molding, so the percentage of elongation must be 1.01 to 1.10, but preferably, 1.03 to 1.05. Here, the percentage of elongation denotes a value obtained by dividing the area of a molded nickel plate by the area of a non-molded nickel plate. When the percentage of elongation does not reach 1.01, the metal plate is not a curved plate. When the percentage of elongation exceeds 1.10, the metal plate is deformed severely and uniformly, so that the hologram pattern is crushed.

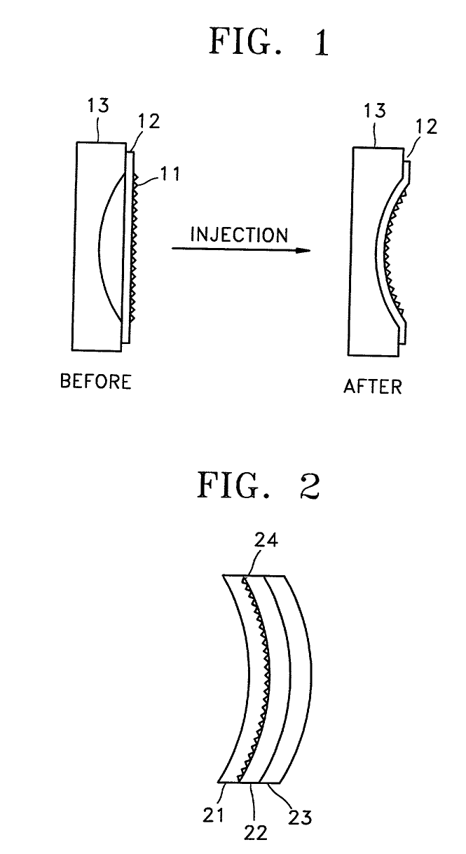

FIG. 1 is a schematic view illustrating an injection process during which a metal plate 12 engraved with a hologram 11, the metal plate fixed to a moving plate 13 of an injection mold, is stretched or elongated. As shown in FIG. 1, the metal plate 12 is fixed to the moving plate 13 of an injection mold, and then the flexible metal plate 12 is deformed by the injection of melted plastic resin at a high pressure, and thus is closely attached to the moving plate 13 of an injection mold along its curved surface. Simultaneously, the hologram is transferred to the melted plastic resin using the metal plate closely attached to the curved surface as a mold, and the metal plate is cooled within the mold and removed therefrom, thereby obtaining a plastic molding to which a hologram has been transferred. Here, the metal plate closely attached to the curved surface of the moving plate 13 of an injection mold becomes more solidly fixed to the moving plate 13 due to the overall deformation of the metal plate, such that the plastic molding having a hologram can be repeatedly produced through the subsequent injections.

<Third process: deposition of highly refractive material>

Hereinafter, the plastic molding is sometimes referred to as a polymer lens. In the third process, a material having a refractive index that is higher than that of the polymer, preferably 2.0 to 2.5, is deposited on the hologram surface of the polymer lens, so that the hologram can be effectively observed due to the refractive index difference between the deposited highly refractive material layer and the polymer lens. Also, the deposited material intercepts between an ultraviolet (UV)-coating layer and an acrylate-family resin layer, thereby preventing degradation of the hologram effect due to the UV-coating layer. Deposition can be performed by typical methods used in the art, such as, melting, wiring, sputtering, an electron beam method, or the like. Here, the highly refractive material used for deposition is titanium oxide or aluminum or the like, and the thickness of deposition is set to be 50 to 500 Å, but preferably, 100 to 300 Å. When the thickness of deposition does not reach 50 Å, the hologram effect is degraded. When the thickness of deposition exceeds 500 Å, the deposition layer may break.

<Fourth process: coating of UV-blocking material>

The plastic molding on which the highly refractive material has been deposited is coated with a UV-blocking material. This process allows a lens on which a highly refractive material has been deposited to suppress the transmission of UV rays. Also, the highly refractive deposited surface of the plastic molding is coated with the UV-blocking material to maintain the hologram effect caused due to the refractive index difference from the highly refractive deposited surface. The coating of the UV-blocking material can be accomplished by typical methods such as, dipping, spraying or the like. Here, the UV-blocking material is a material typically used in the art, such as, an acrylate-family polymer which contains a UV-absorbing agent or a photo initiator. The thickness of a coated layer is set to be 0.1 to 100 μm, but preferably, 0.5 to 50 μm. When the thickness of the coated layer does not reach 0.1 μm, the hologram layer cannot be sufficiently protected. When the thickness of the coated layer exceeds 100 μm, the hologram effect is degraded because of the UV-blocking material.

The structure of the curved lens having a three-dimensional hologram, fabricated by the method described above, is schematically shown in FIG. 2. As shown in FIG. 2, the curved lens according to the present invention has a three-layered structure in which a highly refractive material 22 is deposited on a plastic resin 21 and then coated with an UV-blocking material 23. Here, a hologram 24 is positioned between the plastic resin 21 and the highly refractive material 22. A large amount of refraction occurs when light passes through the highly refractive material 22. Part of the refracted light is reflected by the layer of the hologram, thereby obtaining a hologram image.

Hereinafter, the present invention will be described in detail by explaining preferred embodiments of the present invention. It will be apparent to one of ordinary skill in the art that these embodiments do not limit the scope of the present invention.

<First embodiment: the manufacture of a polymethylmetacrylate curved lens having a hologram>

First, a nickel metal plate on which a hologram is formed is plated with a 80 μm thickness of chromium, using a nickel (Ni)-sulfamate plating solution containing a 85 g/L concentration of nickel, at 42° C. and a pH of 4.0. Then, the chrominum-plated nickel plate is inserted into and fixed to the moving plate of an injection mold having a cavity curved like a lens. Finally, polymethylmetacrylate (PMMA) is injected into the mold to which the nickel metal plate is fixed. Thus, the nickel metal plate is stretched or elongated along the curved surface of the injection molding moving plate, and simultaneously, the hologram on the nickel metal plate is transferred to the PMMA resin. Injection was made at an injection temperature of 220° C., a molding temperature of 60° C., and at an injection pressure of 70 kg/cm². After the injection, the mold is cooled for 20 seconds, and the injection resultant structure is removed from the mold, thereby obtaining a PMMA lens to which the hologram has been transferred. The percentage of elongation of the nickel metal plate measured 1.04 from the removed lens.

Aluminum is deposited on the PMMA lens by a wire method to have a thickness of 150 Å, and the deposition surface of the PMMA lens is coated with dipentaerythritol pentaacrylate including N,N-dimethyl-4-amibenzoicacide 2-ethylhexylester and benzyldimethyl ketal, by a spraying method, and then UV-cured, thereby forming a UV-blocking film having an average thickness of 20 μm.

<Material property test of curved hologram lens>

A material property test was performed according to the Korean standard (KS) for estimating sunglass lenses (see Table 1), in order to determine whether the curved hologram lens fabricated in the first embodiment is functionally suitable. As shown in Table 1, the power and parallelism of the PMMA lens fabricated by the method described above passes the standard values for sunglass lenses, and the generation of color stripes in existing plastic sunglasses was completely prevented.

A curved lens having a hologram, according to the present invention, does not apply a strain to the eyes of lens-wearers since no stripes and no distortion are generated upon assembly with the rim of a pair of eyeglasses, in contrast with plane lenses.

TABLE 1
Results of a material property test on a hologram lens
according to the present invention

| test items | unit | standard | test results |
|---|---|---|---|
| power | diopter | 0.06 and less | 0.06 |
| parallism | prism diopter | 0.16 and less | 0.01 |
| UV permittivity | % | — | 0.2 |
| (310-380 nm) | | | |
| visible ray permittivity | % | — | 9 |
| (380-380 nm) | | | |
| strain (deformation) | | serious color stripes | suitable |
| | | are not permitted | (no serious |
| | | | color |
| | | | stripes) |

| | |
|---|---|
| test method | KS P 4404-94. (sunglass lenses) |

*Results of test made by Korean Commodity Test Research Institute

As described and demonstrated above, the present invention provides a method of fabricating a curved lens having a hologram, wherein a chromium-plated metal plate on which a hologram is formed is fixed to a moving plate of an injection mold having a curved cavity, plastic resin is injected and molded, the metal plate is stretched or elongated, and simultaneously, the hologram of the elongated metal plate is transferred to the plastic resin, a highly refractive material is then deposited on the injected plastic, and the resultant structure is coated with a UV-blocking material, and a plastic lens fabricated by the method. A plastic curved lens having a hologram fabricated by the method of the present invention passes the standard values for sunglass lenses in terms of power and parallelism, and can obtain a distinct hologram image by completely preventing generation of color stripes, which is the most serious problem in existing plastic curved lenses. Also, the curved hologram lens according to the present invention, does not strain the eyes of lens-wearers since no stripes and no distortion are generated upon assembly with the rim of a pair of eyeglasses, in contrast with plane lenses. Therefore, the hologram lens is applicable to sunglass lenses and various laser goggles.

What is claimed is:

1. A method of fabricating a curved lens having a hologram, the method comprising:
forming a hologram on a metal plate;
plating the metal plate on which the hologram is formed;
forming a injected plastic which is curved and the hologram is formed, using an injection-molding;
forming a highly refractive material film on the injected plastic on which the hologram is formed; and
coating an ultraviolet (UV)-blocking material film on the highly refractive material film.

2. The method of claim 1, wherein a metal plate is plated using nickel or copper.

3. The method of claim 1, wherein the thickness of plating is 50 to 500 μm.

4. The method of claim 1, wherein the plastic resin is an acrylate-family polymer.

5. The method of claim 1, wherein the elongation ratio of the metal plate is 1.01 to 1.10

6. The method of claim 1, wherein the highly refractive material film is formed of a material film having a refractive index of 2.0 to 2.5

7. The method of claim 1, wherein the thickness of the deposited highly refractive material film is 50 to 500 Å.

8. The method of claim 1, wherein the thickness of the coated UV-blocking material film is 0.1 to 100 μm.

9. The method of claim 6, wherein the material film is formed of titanium oxide film.

10. The method of claim 6, wherein the material film is formed of aluminum.

11. The method of claim 1, the step of forming a injected plastic further comprises steps of fixing the metal plate to a moving plate of an injection mold having a curved cavity; and
elongating the metal plate injection-molding a plastic resin and, simultaneously, transferring the hologram of the elongated metal plate to the plastic resin.

12. A curved lens having a hologram, the curved lens comprising:
a curved plastic resin;
a hologram which is formed on the curved plastic resin;
a highly refractive film which is formed on the plastic resin having the hologram; and
an ultraviolet (UV)-blocking material film which is formed on the highly refractive film.

13. The curved lens of claim 12, wherein the highly refractive film is a refractive film having a refractive index of about 2.0-2.5.

14. The curved lens of claim 13, wherein the refractive film is a titanium oxide film.

15. The curved lens of claim 13, wherein the refractive film is an aluminum film.

16. The curved lens of claim 12, wherein the plastic resin is an acrylate polymer.

17. The curved lens of claim 12, wherein, the UV-blocking material film is an acrylate polymer.
